(19) United States
(12) Patent Application Publication
(10) Pub. No.: US 2013/0128572 A1
(43) Pub. Date: May 23, 2013

(54) REFLECTING PLATE UNIT AND ILLUMINATING TOOL FOR CEILING USING THE SAME

(71) Applicant: IZ co., Ltd., Kamiina-gun (JP)

(72) Inventor: Shiro Yoshizawa, Kamiina-gun (JP)

(73) Assignee: IZ co., Ltd., Kamiina-gun (JP)

(21) Appl. No.: 13/670,785

(22) Filed: Nov. 7, 2012

(30) Foreign Application Priority Data
Nov. 18, 2011 (JP) 2011-252601

(51) Int. Cl. F21V 21/03; F21V 7/00

(52) U.S. Cl. CPC F21V 21/03; F21V 7/00
USPC 362/235

(57) ABSTRACT

A reflecting plate unit includes a reflecting plate (1) attached to an illuminating tool; an LED base plate (10) which is attached to the reflecting plate (1) and to which LED elements are attached side by side in lengthwise direction; a light transmitting cover (20) which includes a substantially cylindrical member with an opening (20a) cut out from one end to the other in lengthwise direction, which is engaged with the reflecting plate (1) in attachable and detachable manner so as to cover the LED base plate (10) and which transmits light in a part or as a whole; engaging portions (30m, 20f) provided in the reflecting plate (1) and the light transmitting cover (20) respectively for causing the reflecting plate (1) and the light transmitting cover (20) to be engaged with each other and allowing them to slide one relative to the other in lengthwise direction.

### FIELD OF THE INVENTION

The present invention relates to a reflecting plate unit and an illuminating tool using the same. More specifically, the present invention relates to a reflecting plate unit in which a light transmitting cover covering LED chips is secured to be attachable and detachable and an illuminating tool for ceiling in which the reflecting plate is used to be attachable and detachable.

### BACKGROUND OF THE INVENTION

Illuminating tools for ceiling are generally used in which two fluorescent lamps are disposed in parallel. However, an illuminating tool for ceiling with two fluorescent lamps consumes much electric power and obliges as much economic burden. Also with an illuminating tool for ceiling with two fluorescent lamps, room temperature is raised due to heat generation by multitudes of lamps and air conditioners must be operated more, thus requiring more electric power to be consumed. There is such a problem for an illuminating tool with two fluorescent lamps.

In recent years, an illuminating tool for ceiling has been changed from one with two fluorescent lamps to one with a fluorescent lamp in view of saving consumed energy. This owes to the fact that illuminating tools for ceiling with a fluorescent lamp, which can secure similar illuminance as one with two fluorescent lamps due to an effect of a reflecting plate unit, are being sold in the market to be widespread. For this reason, operations has been increasing in recent years that exchange the illuminating tools with two fluorescent lamps used previously with ones with a fluorescent lamp. On the other hand, it is expected greatly that illuminating tools with LED be widespread, because they seem to be means for realizing reduction of exhausted carbon dioxide amount and preventing global warming.

At present, majority of illuminating tools for ceiling are ones using fluorescent lamps. If those using fluorescent lamps can be exchanged with illuminating tools with LED having higher illumination efficiency, energy consumed in illumination could be saved. For this sake, study and development of illuminating tools with LED are promoted in Japan and other countries. For such illuminating tools with LED, LED base plates have been supplied in which plurality of small LED elements are disposed in linearly spaced apart configuration.

Further, conventional techniques concerning an illuminating device using an LED base plate like a fluorescent lamp (hereinafter referred to as an LED illuminating device) will be explained referring to patent documents. A technique of an LED illuminating device is known which comprises a base plate with plurality of LED elements provided on its surface, a glass tube that houses the base plate bridging two spaced apart points of the inner surface of the base plate and adhesive joining the base plate and the glass tube (for example, see Japanese published application No. 2011-138681: Patent Document 1). Also, a technique of an illuminating tool is known with which temperature of LED can be prevented from rising to make illumination output higher and peripheral area of the light emitting parts can be restrained from darkening (for example, see Japanese published application No. 2011-150815: Patent Document 2).

However, in the technique disclosed in Patent Document 1, a base plate is disposed within a glass tube. It is necessary to pay specific attention in dealing with a glass tube because of its brittleness. Operation for attaching or detaching a glass tube is not easy but requires much load for it. There is a problem that breakage of a glass tube during operation may bring about danger on the operator as well as oblige expense. Further, in the technique disclosed in Patent Document 2, a light transmitting cover has connection legs provided in it and is attached by inserting the connection legs into engaging holes provided in a reflecting plate.

Here, it is necessary to pay specific attention in attaching or detaching the light transmitting cover because of fragility of connection legs. Further, connection legs are provided in specific parts of the light transmitting cover, which is connected to a reflecting plate with the specific parts alone. Consequently, there is a problem that deformation may occur in the light transmitting cover due to its weight and the cover may not endure long term use. For these reason, there is a problem that it is not easy to perform operation of attaching or detaching LED illuminating devices in conventional illuminating tools for ceiling.

### SUMMARY OF THE INVENTION

The present invention has been made for solving the above mentioned problems and attained the following objects. It is an object of the present invention to provide a reflecting plate unit which does not require plenty of parts or many steps of operation and can be easily attached to an illuminating tool for ceiling. It is another object of the present invention to provide a reflecting plate unit for which operation of attaching the reflecting plate unit to or detaching the same from an illuminating tool for ceiling can be performed in a state where a light transmitting cover and LED devices are secured to the reflecting face. It is still another object of the present invention to provide an illuminating tool for ceiling in which a reflecting plate unit can be easily attached to or detached from an illuminating tool for ceiling without giving any danger on the operator when renewal working of previously established illuminating tools is made.

The present invention has following means in order to attain the above mentioned objects.

The reflecting plate unit according to the present invention 1 comprises: a reflecting plate attached to an illuminating tool for ceiling provided on the ceiling in attachable and detachable manner with the back face opposite to the face of the side attached to the ceiling forming a face that reflects light, an LED base plate which is attached to the reflecting plate and to which plurality of LED elements are attached side by side in lengthwise direction, a light transmitting cover which is composed of substantially cylindrical member with an opening cut out from one end to the other in lengthwise direction, which is engaged with the reflecting plate in attachable and detachable manner so as to cover the LED base plate and which transmits light in a part or as a whole, engaging portions provided in the reflecting plate and the light transmitting cover respectively for causing the reflecting plate and the light transmitting cover to be engaged with each other and allowing them to slide one relative to the other in lengthwise direction.

The reflecting plate unit according to the present invention 2 is characterized in that, in the present invention 1, the engaging portions comprises: engaging male tags formed on the reflecting face so as to protrude from the side of the reflecting face, and engaging female grooves provided in the light transmitting cover as grooves formed to be engaged with the engaging male tags.

The reflecting plate unit according to the present invention 3 is characterized in that, in the present invention 2, the engaging male tags are formed in lengthwise direction of the reflecting plate from one end to the other, and the engaging female grooves are formed in lengthwise direction of the light transmitting cover from one end to the other.

The reflecting plate unit according to the present invention 4 is characterized in that, in the present invention 3, the engaging male tags are formed to be rails that extend outside along the two lengthwise sides of the LED base plate, and the engaging female grooves are formed at opening edges as the both ends of the light transmitting cover on the opening side.

The reflecting plate unit according to the present invention 5 is characterized in that, in the present invention 4, the engaging male tags are formed to have a determined inclination angle to the reflecting face, and the engaging female grooves are formed to have a determined inclination angle to the plane of the opening.

The reflecting plate unit according to the present invention 6 is characterized in that, in the present invention 5, the engaging male tags are formed by bending a engaging plate consisting of a plate, and the engaging plate is attached to be sandwiched between the reflecting face and the LED base plate.

The reflecting plate unit according to the present invention 7 is characterized in that, in the present invention 6, a fixing plate for fixing the engaging plate to the reflecting face is attached between the LED base plate and the engaging plate, through holes for causing bolts or rivets to be inserted at more than one positions of the fixing plate, the LED base plate and the engaging plate, and the fixing plate, the LED base plate and the engaging plate fastened with the bolts or rivets.

The illuminating tool for ceiling according to the present invention 8 is an illuminating tool for ceiling in which the reflecting unit according to the present invention 1 is provided and characterized in that it comprises: an illuminating tool body comprising a top plate of a flat shape to be attached to ceiling, having an opening on the side opposed to the top plate and contouring a housing space for housing the reflecting plate unit, end plates that are provided at both ends on short sides of the top plate and to which packing members for sealing both ends of the light transmitting cover are provided in attachable and detachable manner, and fixing means for fixing the reflecting plate unit to the illuminating tool body.

The illuminating tool for ceiling according to the present invention 9 is characterized in that, in the present invention 8, the fixing means comprises: through holes formed in each of the reflecting plate, the LED base plate, the light transmitting cover and the engaging plate, holes for screw formed in the securing base for the reflecting plate, and screws inserted through the through holes and screwed into the holes for screw respectively.

The reflecting plate unit according to the present invention 10 is characterized in that, in the present invention 1, the engaging portions comprises: engaging female grooves formed in the engaging plate attached to the reflecting face and consisting of grooves formed on one face of the engaging plate from one side to the other in lengthwise direction, and engaging male tags formed at the opening edges on the opening side of the light transmitting cover from one side to the other in lengthwise direction and formed to be rails for engagement with the engaging female grooves.

The reflecting plate unit according to the present invention 11 is characterized in that, in the present invention 10, the engaging male tags are formed so as to protrude inwards of the light transmitting cover.

The reflecting plate unit according to the present invention 12 is characterized in that, in the present invention 11, the engaging plate has: an opening concave extending from one end to the other in lengthwise direction with width smaller than the short side of the LED base plate and larger than the width of the LED element, and inner grooves formed on the engaging plate from one end to the other continuously to the opening concave at both sides and formed so that the distance between the depths of inner grooves is substantially the same as the short side of the LED base plate; and further characterized in that the LED base plate is provided so that it can slide relative to and along the inner grooves in lengthwise direction and is provided so as to be attached to and detached from the engaging plate.

The reflecting plate unit according to the present invention 13 is characterized in that, in the present invention 12, the engaging plate is made of aluminum molded through extrusion.

The illuminating tool for ceiling according to the present invention 14 is an illuminating tool for ceiling in which the reflecting unit according to the present invention 10 is provided and characterized in that it comprises: an illuminating tool body comprising a top plate of a flat shape to be attached to ceiling, having an opening on the side opposed to the top plate and contouring a housing space for housing the reflecting plate unit, and holding springs provided on both ends on the short sides of the top plate for holding the light transmitting cover.

The illuminating tool for ceiling according to the present invention 15 is characterized in that, in the present invention 14, it comprises: engaging male portion formed by bending a plate to be in substantially U-shape and fixed to the side opposite to the reflecting face of the reflecting plate at substantially center thereof, and engaging female hole portion fixed to the lower side of the top plate at substantially center thereof and having an engaging hole as a through hole for inserting the engaging male portion formed thereon; and further characterized in that the engaging male portion is fixed at the engaging female hole potion with elastic force and the reflecting plate is fixed to the illuminating tool body.

The reflecting plate unit according to the present invention does not require plenty of parts or many steps of operation and can be easily attached to an illuminating tool for ceiling. Moreover, for the reflecting plate unit of the present invention, operational steps performed on the ceiling for installing can be reduced because operation of attaching the reflecting plate unit to or detaching the same from an illuminating tool for ceiling can be performed in a state where a light transmitting cover and LED devices are secured to the reflecting face. Further, in the illuminating tool for ceiling according to the present invention, a reflecting plate unit can be easily attached to or detached from an illuminating tool for ceiling without giving any danger on the operator when renewal working of previously established illuminating tools is made.

### BRIEF DESCRIPTION OF THE DRAWINGS

FIG. 1 is an external perspective view showing an illuminating tool for ceiling according to an embodiment of the present invention.

FIG. 2 a perspective view showing the disintegrated parts of the illuminating tool for ceiling in a state where the reflecting plate and light transmitting cover are detached.

FIG. 3 is an enlarged sectional view of FIG. 1 taken along the line A-A showing the disintegrated parts.

FIG. 4 is an enlarged sectional view taken along the direction perpendicular to the lengthwise direction showing an illuminating tool for ceiling according to another embodiment 1 of the present invention.

FIG. 5 is a sectional view taken along the direction perpendicular to the lengthwise direction showing an illuminating tool for ceiling according to another embodiment 2 of the present invention.

FIG. 6 is an enlarged sectional view taken along the direction perpendicular to the lengthwise direction showing an illuminating tool for ceiling according to another embodiment 2 of the present invention.

FIG. 7 is an external view showing a reflecting plate of an illuminating tool for ceiling according to another embodiment 3 of the present invention.

FIG. 8 is a view showing the disintegrated parts of the illuminating tool for ceiling in a state where the reflecting plate, LED base plate and light transmitting cover are detached.

FIG. 9 is a partially enlarged view showing the disintegrated parts of the illuminating tool for ceiling in a state where the reflecting plate, LED base plate and engaging plate are detached.

FIG. 10 is an enlarged sectional view of FIG. 7 taken along the line B-B showing a state where the reflecting plate is not attached to the illuminating tool body.

FIG. 11A-E is a plurality of sectional views showing a situation where the reflecting plate is being attached.

### DETAILED DESCRIPTION OF THE PREFERRED EMBODIMENTS

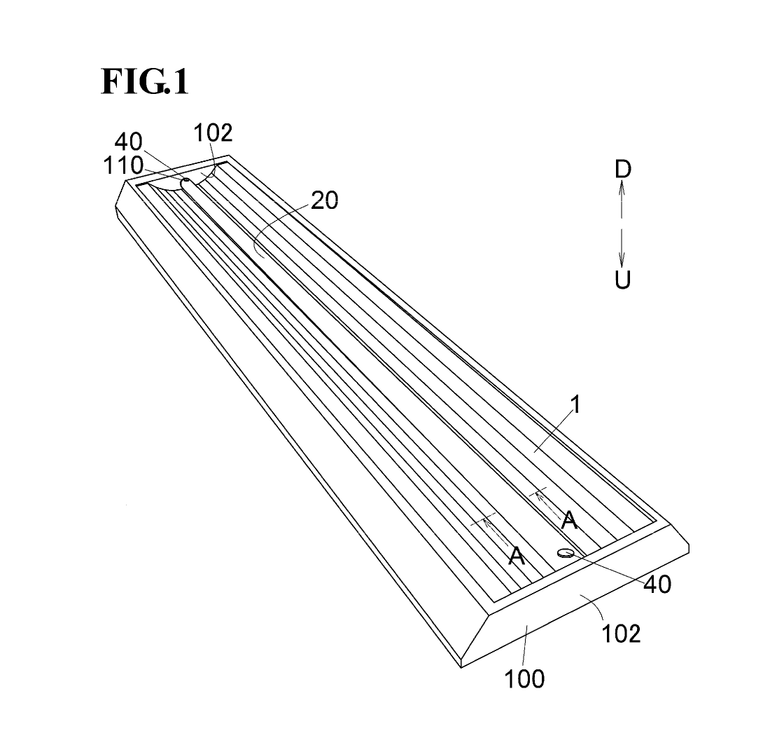

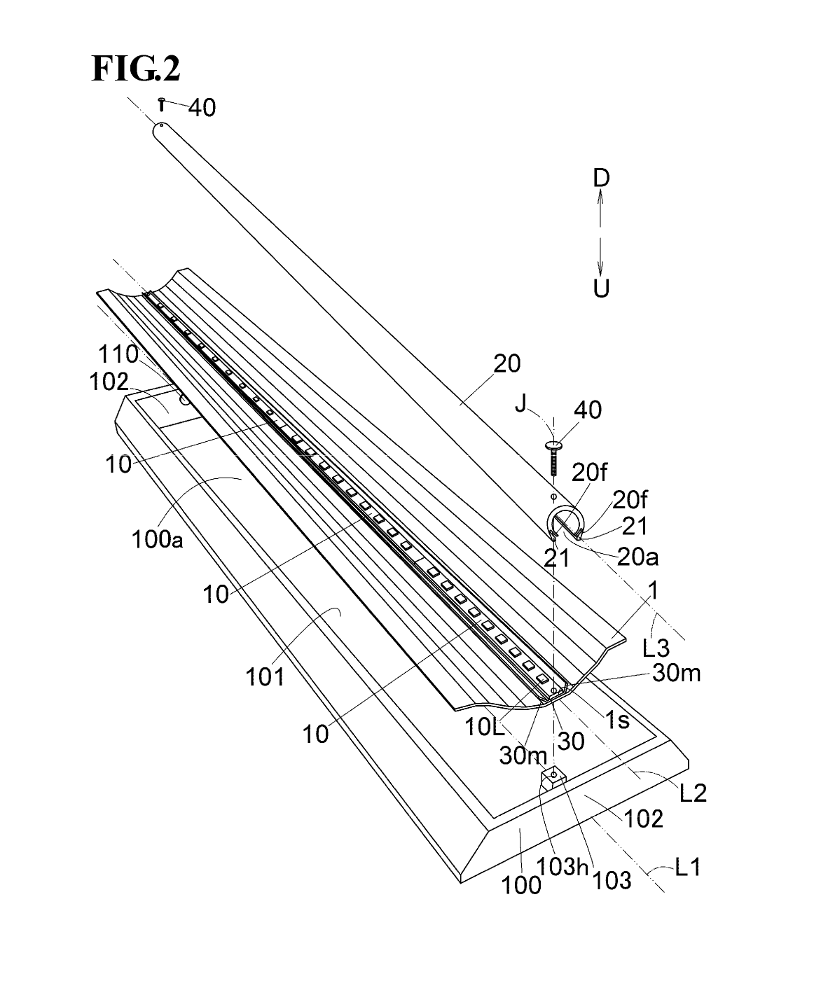

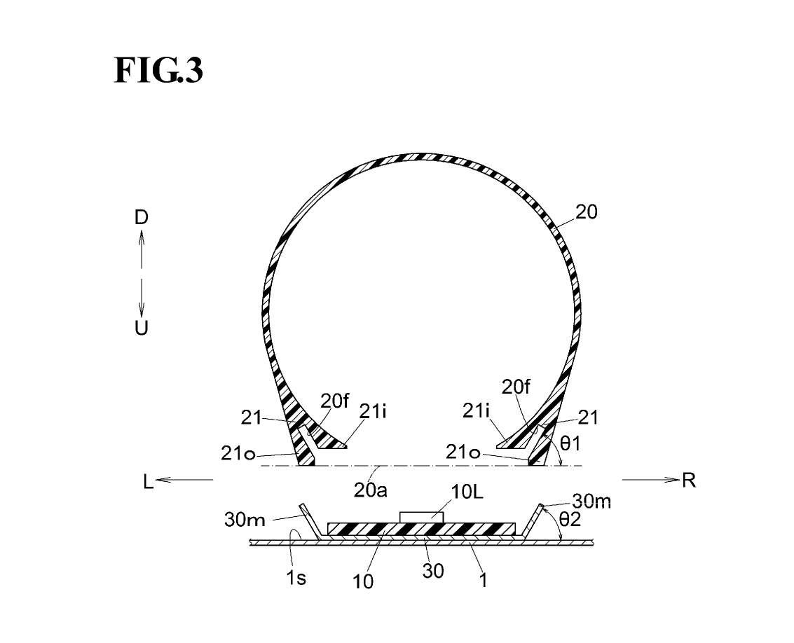

Embodiments of a reflecting plate unit and an illuminating tool for ceiling according to the present invention will be explained below referring to drawings. FIG. 1 is an external perspective view showing an illuminating tool for ceiling according to an embodiment of the present invention. FIG. 2 a perspective view showing the disintegrated parts of the illuminating tool for ceiling in a state where the reflecting plate and light transmitting cover are detached. FIG. 3 is an enlarged sectional view taken along the line A-A in FIG. 1 showing the disintegrated parts. Here, the reflecting plate is shown as placed on the illuminating tool for ceiling. Here, the illuminating tool for ceiling is shown reversed for up and down and the ceiling as being in downward position for convenience in explanation.

For convenience' sake, explanation will be made so that the side on which an illumination tool for ceiling is installed is in upward direction (direction of the arrow U) and the side of the floor is in downward direction (direction of arrow D). It is assumed that the illuminating tool for ceiling has a rectangular outline shape with long sides and short sides. The center line between the two long sides of a top plate 101 (mentioned later) in parallel with the two long sides is denoted as the center line L1. The center line between the two long sides of a reflecting plate 1 in parallel with the two long sides is denoted as L2. The line passing through the respective centers of the both end faces perpendicular to the longitudinal direction of a light transmitting cover 20 is denoted as L3.

### (The Illuminating Tool Body)

As shown in FIGS. 1 and 2, a reflecting plate 1 and a light transmitting cover 20 are attached to an illuminating tool body 100. The illuminating tool body 100 is formed to have a configuration that is rectangular in the plan view and substantially trapezoidal in side view in a state where the illuminating tool body is installed on the ceiling. The illuminating tool body 100 is formed through working of bending a sheet of or sheets of aluminum or the like. The illuminating tool body 100 opens downwards and has a symmetric and substantially trapezoidal shape with the upper side on the ceiling side longer than the downward side in a state where the illuminating tool body is installed on the ceiling.

As shown in FIG. 2, the illuminating tool body 100 is provided with a flat top plate 101 of a rectangular shape and secured to the ceiling with fixing means such as screws or the like. The illuminating tool body 100 is composed of a top plate 101, end plates 102 and inclined plates 103 and forms a housing space 100a. Consequently, the illuminating tool body 100 is so formed as to be a box-like shape with an open face confronting to the top plate 101. This housing space 100a is formed so as to install a reflecting plate 1 within the illuminating tool body 100.

The illuminating tool body 100 has a stabilizer as a lighting device, a terminal base for a power source or the like (not shown) within it. Securing bases 104 for the reflecting plate are secured to the lower face of the top plate 101 of the illuminating tool body 100 at both ends on the short sides respectively. The securing bases 104 for the reflecting plate are provided for securing the reflecting plate 1 to the illuminating tool body 100. The securing bases 104 for the reflecting plate are disposed on the center line L1, being secured at two places on the short sides and each of them has a hole 104h for screw on the center position.

### (Packing Members 110)

End plates 102 of the illuminating tool body 100 are formed integrally at both ends on the short sides of the top plate 101 respectively. Packing members 110 are attached to substantially center position of the inner faces of the end plates 102 respectively. Packing members 120 are provided for sealing both ends of the light transmitting cover 20 as mentioned later and used to fit in both ends of the light transmitting cover 20 in attachable and detachable manner. The packing members 110 are formed of soft and elastic material such as rubber, synthetic resin or the like so as to seal both ends of the light transmitting cover 20. The packing members can prevent insects flying towards light from entering or dusts from remaining there by sealing both ends of the light transmitting cover 20. These packing members 110 are preferably provided so as to be attachable and detachable so that they can be exchanged in case of deterioration.

(Reflecting Plate 1)

As shown in FIGS. 2 and 3, an LED base plate 10, a light transmitting cover 20 and an engaging plate 30 are attached to the reflecting face as one face of the reflecting plate 1 according to this embodiment. A through hole (not shown) is provided at each of both ends on the center line L2. The reflecting plate 1 is secured to the illuminating tool body 100 by threading screws 40 into the holes 104h for screw in the securing bases 104 for the reflecting plate. The reflecting plate 1 has plurality of rectangular reflecting faces formed on it by working of a sheet material through bending it. The reflecting plate 1 is formed so that the rectangular reflecting faces are side by side in parallel manner with their long sides abutting each other.

The reflecting plate 1 is of a substantially rectangular shape in plan view and has a mountain-like shape with slackly inclined and symmetrical faces viewed in edgewise direction. The top face 1s is the top of the reflecting plate 1 formed in a mountain-like shape and is the face nearest to the ceiling face when the reflecting plate 1 is secured to the illuminating tool body 100. The top face 1s is of an elongated rectangular surface provided so as to be in parallel with the ceiling face when the illuminating tool body 100 is installed to the ceiling. The LED base 10, light transmitting cover 20 and engaging plate 30 are secured to the top face 1s.

The reflecting plate 1 has reflecting faces formed by a method of physical vaporization called as PVD coating of glass-like material using titanium or silicon. For this, irradiation light is not reflected by aluminum as the base material but reflected by the reflecting face as the surface of the reflecting plate 1 coated by PVD, with which such a high reflectivity as 94% can be obtained. Moreover, the reflecting face of the reflecting plate 1, formed by PVD coating, has such features that it is excellently wear proof, excellent in hardness for working under high temperature, not susceptible damage or the like. Further, the reflecting plate 1 is durable and can maintain high reflectivity without discoloration or peeling in the surface.

Further, working of embossing is applied on the surface of the reflecting plate 1 according to this embodiment. With surface working of embossing applied, the reflecting plate 1 can diffuse as well as reflect the irradiated light from LED elements 10L. That is, as irradiation light is diffused as well as reflected (irregularly reflected), the surface of the reflecting plate looks whitish as a whole without looking blackish, thus improving design appearance. Here, it goes without saying that the reflecting face may be one by working into a mirror surface or satin-like surface according to the position where an illuminating tool for ceiling is installed or the objects for illumination.

### (LED Base Plate 10)

As shown in FIG. 2, an elongated and flat LED base plate 10 is attached to the top face 1s of the reflecting plate 1 via an engaging plate 30. The LED base plate 10 and the engaging plate 30 are secured with a silicone double-face adhesive tape in this embodiment. The member for securing the LED base plate 10 and the engaging plate 30 is preferable to be of a material efficiently conducting heat generated in the LED base plate 10. Here, the LED base plate 10 and the engaging plate 30 need not necessarily be secured with tackiness agent or adhesive. As mentioned later, this is because the LED base plate 10 is pressed to be fixed by inner edge portions 21i of the light transmitting cover 20, when engaging male tags 30m of the engaging plate 30 is engaged with engaging female grooves 20f of the light transmitting cover 20 (see FIG. 3).

As shown in FIG. 2, plurality of LED elements 10L are disposed with an equal distance therebetween on the lower face of the LED base plate. In this embodiment, three LED base plates 10 are disposed in series, which are totally referred to as LED base plate 10. A through hole for making a screw 40 pass through is formed at each of both ends of the three LED base plates 10 as a whole, that is, at an end of each individual outer side LED base plate 10. The LED base plate 10 is connected with a power source line and the LED elements 10 L emit light through supplying electric power to the LED base plate 10. It goes without saying that the number of the LED elements 10L provided on the LED base plate 10 may be decided conveniently according to necessary illuminance, dimensions of the illuminating tool body to be used or the like.

### (Light Transmitting Cover 20)

As shown in FIG. 2 and 3, the light transmitting cover 20 is one with a semi-cylindrical or substantially cylindrical shape for covering the LED base plate 10. The light transmitting cover corresponds to the glass tube of a fluorescent lamp or the like that has been used conventionally as a light source of a illuminating tool and serves to diffuse irradiation light to be uniform illumination light. The whole or parts of the light transmitting cover 20 is composed of light transmitting material, specifically of polycarbonate as a synthetic resin that can be deformed elastically. The light transmitting cover 20 is formed through extrusion of resin such as polycarbonate. While the light transmitting cover 20 is made of polycarbonate, other synthetic resins may be used as long as they can be deformed elastically (for example, ABS resin or acrylic resin).

As shown in FIG. 2, the light transmitting cover 20 has an opening 20a extending in lengthwise direction (direction of the center line L3) from one end to the other. The light transmitting cover 20 on the side of the opening 20a is secured to the reflecting plate 1 so as to cover the LED base plate 10. A through hole is formed at each of both ends in lengthwise direction of the light transmitting cover 20. Engaging female grooves 20f, 20f are formed in respective opening edges 21, 21 as the ends of the light transmitting cover on the opening sides. These engaging female grooves 20f, 20f are formed to be of a cut out shape from one end to the other in lengthwise direction of the opening edges 21, 21 respectively. The engaging female grooves 20f, 20f are engaging portions for making the light transmitting cover 20 slide along the engaging plate 30 in lengthwise direction and are engaged with the engaging male tags 30m, 30m of the engaging plate 30 respectively. The engaging female grooves 20f, 20f are inclined symmetrically in sectional view and formed to be opened downward elastically.

The inclination angle θ1 of the engaging female groove 20f is set to be the same as the inclination angle θ2 of the engaging male tag 30m. Here, the inclination angle θ1 of the engaging female groove 20f is an angle between the plane of the opening 20a and the engaging female groove 20f and the inclination angle θ2 of the engaging male tag 30m is an angle between the top face 1s and the engaging male tag 30m. In the opening edges 21, 21, inner edge portions 21i, 21i are formed on the inner sides of the engaging female grooves 20f, 20f respectively and outer edge portions 21o, 21o are formed on the outer sides of the engaging female grooves 20f, 20f respectively. Here, the inclination angle θ1 and the inclination angle θ2 may be set to be different.

As shown in FIG. 3, the inner edge portions 21i serves to press the LED base plate 10 towards the engaging plate 30 when the engaging female grooves are engaged with the engaging male tags 30m respectively. The outer edge portions press the reflecting plate 1 when the engaging female grooves are 21o engaged with the engaging male tags 30m respectively. In such a manner, as the inner edge portions 21i and the outer edge portions 21o press the LED base plate 10 and the reflecting plate 1, the light transmitting cover 20 is engaged with the reflecting plate 1 to be secured thereto. The light transmitting cover 20 is preferably formed through molding so that each of the lengthwise grooves has a deformed configuration in which the width is narrower at both ends in lengthwise direction, in order to be securely fixed to the reflecting plate 1. The reason of this is in that, when the engaging female grooves 20f are inserted from one end of the engaging male tags 30m, resistance to sliding becomes lower to allow easier assembling and yet secure holding can be attained because the width is narrower at both ends of the engaging female grooves 20f in lengthwise direction.

### (Engaging Plate 30)

As shown in FIG. 3, the engaging plate 30 is secured to the top face 1s of the reflecting plate 1. The engaging plate 30 is a plate of metal (for example aluminum) provided between the reflecting plate 1 and the LED base plate 10. The engaging plate 30 is secured fixedly to the top face of the reflecting plate 1 with rivets, screws or the like. The engaging plate 30 is bent at both edges in the elongated sides to form the engaging male tags 30m, 30m. The engaging male tags 30m, 30m are engaging portions so as to allow the light transmitting cover 20 to slide in lengthwise direction of the engaging plate 30, being engaged with the engaging female grooves 20f, 20f of the light transmitting cover 20 respectively, as mentioned above.

As shown in FIG. 3, the engaging male tags 30m, 30m are formed to protrude from the reflecting plate 1 side to the LED base plate 10 side as viewed in section. The engaging male tags 30m, 30m at both edges are formed to be rails that extend outside along the two lengthwise sides of the LED base plate 10. That is, the engaging tags 30m, 30m at both edges are formed by bending the engaging plate 30 so that they are symmetrical as viewed in section and inclined with an angle θ2 from the top face 1s.

As shown in FIG. 3, the inclination angle θ1 of the engaging female grooves 20f of the light transmitting cover 20 is set to be the same as or slightly smaller than the inclination angle θ2 of the engaging male tags 30m of the engaging plate 30. Due to this, the light transmitting cover 20 can slide in lengthwise direction on the engaging plate 30 and is secured to the reflecting plate 1 to be fixed thereto by friction force. A through hole (not shown) is formed at each of both ends in lengthwise direction. The reflecting plate 1, to which the LED base plate 10, the light transmitting cover 20 and the engaging plate 30 are secured, can be secured to the illuminating tool body 100 with screws 40.

In the next, operational method 1 for securing the reflecting plate 1 to the illuminating tool body 100 will be explained referring to FIG. 2. The method 1 for securing the reflecting plate 1 to the illuminating tool body 100 is concerned with the case where the inclination angles θ1 and θ2 are set to be the same. At first, one end of the light transmitting cover 20 in lengthwise direction is brought to one end of the engaging plate 30 in lengthwise direction. Then the engaging female grooves 20f, 20f are inserted on the engaging male tags 30m, 30m. When the light transmitting cover 20 is pushed in towards the engaging plate 30, the engaging female grooves are deformed elastically so that the engaging male tags 30m, 30m are engaged with the engaging female grooves 20f, 20f.

The light transmitting cover 20 is further pushed in and caused to slide on the engaging plate 30 in lengthwise direction so that both ends of the light transmitting cover 20 in lengthwise direction are flush with both ends of the engaging plate 30 in lengthwise direction. Because the width of both ends of the engaging female grooves 20f is set to be narrower than the width of the engaging male tags 30m, the engaging female grooves and the engaging make tags 30m are fixed securely at their respective ends. As the inner edge portions 21i and the outer edge portions 21o press the LED base plate 10 and the reflecting plate 1, the light transmitting cover 20 is fixed securely to the reflecting plate 1. Moreover, even if the LED base plate 10 is not caused to adhere to the engaging plate 30, the LED base plate 10 can be fixed to the engaging plate 30, being pressed by the inner edge portions 21i.

In such a manner, the reflecting plate unit is assembled by attaching the light transmitting cover 20 to the reflecting plate 1. The centers of the through holes formed in the reflecting plate 1, the LED base plate 10, the light transmitting cover 20 and the engaging plate 30 respectively that constitute this reflecting plate unit are disposed on the same axis line J (see FIG. 2). Operational work for assembling the reflecting plate unit is performed on a table for work or on ground favorable for operational work. In the next, the reflecting unit is installed in the housing space 100a of the illuminating tool body 100. In this, packing members 110 attached to the end plate 102 at both ends of the illuminating tool body 100 are caused to fit in at both ends of the light transmitting cover 20. As the reflecting plate unit is attached to the illuminating tool body 100, the center of the holes for screw 104h in the securing bases 104 for the reflecting plate is also on the axis line J. For this, the reflecting plate unit is fixed to the illuminating tool body 100 by inserting the screws 40 into the through holes 104h formed in the reflection plate unit and screwing them.

According to this embodiment, operational steps performed on the ceiling for installing is reduced because the reflecting plate unit is installed on the illuminating tool body 100 after having composed the reflecting plate unit. That is, according to this embodiment, it is not necessary to perform operational work for installing on the ceiling for each of many parts constituting the reflecting tool body 100. Further according to this embodiment, because operational steps performed on the ceiling are reduced, the reflecting plate unit can be easily attached to or detached from an illuminating tool for ceiling without giving any danger on the operator, when renewal operation of previously established illuminating tool for ceiling 100 is performed.

In the next, operational method 2 for securing the reflecting plate 1 to the illuminating tool body 100 will be explained referring to FIG. 2. The method 2 for securing the reflecting plate 1 to the illuminating tool body 100 is concerned with the case where the inclination angle θ1 of the engaging female groove 20f is set to be smaller than the inclination angle θ2 of the engaging male tags 30m. Here, explanation will be omitted as to similar steps of operational method as the operational method 1 for securing the reflecting plate to the illuminating tool body. At first, one end of the light transmitting cover 20 in lengthwise direction is brought to one end of the engaging plate 30 in lengthwise direction. At this time, the opening 20a is widened through widening of the opening edges 21, 21 to right side (direction of arrow R) and left side (direction of arrow L) respectively.

In the state where the opening 20a is widened, the engaging female grooves 20f, 20f are brought to the engaging male tags 30m, 30m. As the light transmitting cover 20 is pushed in towards the engaging plate 30, ends of the engaging female grooves 20f, 20f are deflected elastically and the engaging female grooves 20f, 20f are engaged with the engaging male tags 30m, 30m. The light transmitting cover 20 is further pushed in and caused to slide on the engaging plate 30 in lengthwise direction so that both ends of the light transmitting cover 20 in lengthwise direction are flush with both ends of the engaging plate 30 in lengthwise direction.

The light transmitting cover 20 with the opening 20a widened tends to return to its original state with elastic force. That is, the light transmitting cover 20 tends to return to the state of the inclination angle θ2 of the engaging female groove 20f. For this, the inner edge portions 21i, 21i press the LED base plate 10 to securely fix it. Similarly, the outer edge portions 21o, 21o also press the reflecting plate 1 to securely fix it. In such a manner, as the inner edge portions 21i and the outer edge portions 21o press the LED base plate 10 and the reflecting plate 1 to be fixed, the light transmitting cover 20 is securely fixed to the reflecting plate 1. The reflecting plate unit is assembled by securing the light transmitting cover 20 to the reflecting plate 1. Operational steps for installing the reflecting plate unit on the illumination tool body 100 are similar as in the operation method 1, so its explanation is omitted here.

### Another Embodiment 1

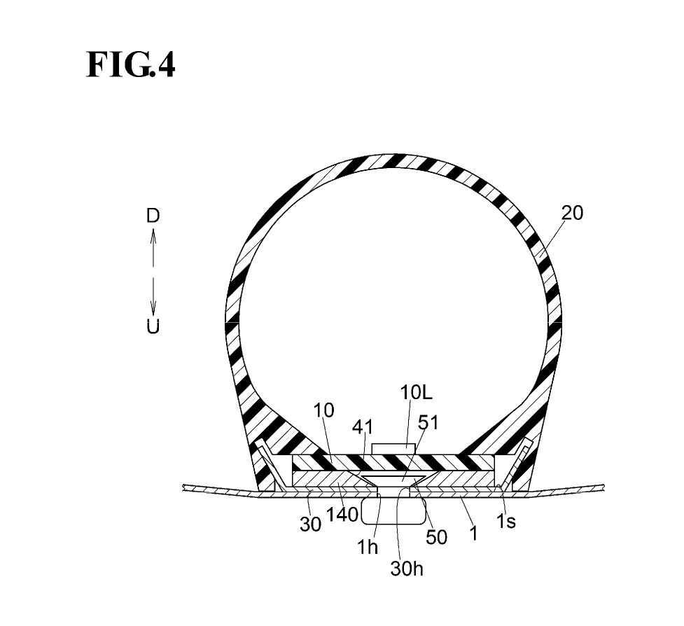

In the next, another embodiment 1 will be explained referring to drawings. Here, in the explanation of another embodiment 1, same reference numbers are denoted to the same portions as shown in the above mentioned embodiment, for which detailed explanation is omitted. FIG. 4 is an enlarged sectional view taken along the direction perpendicular to the lengthwise direction showing an illuminating tool body according to another embodiment 1 of the present invention.

### (Fixing Plate 140)

A fixing plate 140 is provided between the LED base plate 10 and the engaging plate 30. The fixing plate 140 is a rectangular metal plate provided for securely fixing the reflecting plate 10 and the engaging plate 30. The fixing plate 140 is secured to the top face 1s of the reflecting plate 1 along with the engaging plate 30 and the reflecting plate 1. The fixing plate 140 secures the engaging plate 30 and the reflecting plate 1 at plural points with rivets 50.

As shown in FIG. 4, each rivet 50 has a counter sunk portion 51 having a flat surface and a substantially conical lower portion. Plurality of substantially conical through holes 41 for letting the counter sunk portion 51 sink in are formed in the fixing plate 140. Plurality of through holes 30h as cylindrical through holes are formed in the engaging plate 30. Plurality of through holes la as cylindrical through holes is formed in the reflecting plate 1. When the fixing plate 140, the engaging plate 30 and the reflecting plate 1 are overlapped, each center of the conical hole 41, through hole 31h and through hole 1h is in a same axis line.

After the rivets 50 are inserted from the side of the fixing plate 140 and the counter sunc portions 51 of the rivets 50 are sunk, the fixing plate, the engaging plate 30 and the reflecting plate 1 are securely fixed each other by caulking the point of each rivet 50. Because the counter sunk portions 51 of the rivets are sunk in the conical holes 41, no irregularities appear on the fixing plate 140. Here, in another embodiment 1, the LED base plate 10 and the reflecting plate 1 are fixed via the fixing plate 140 with rivets. However, it goes without saying that fixing may be performed not solely by rivets but also any of other fixing members (for example, screws or the like).

### Another Embodiment 2

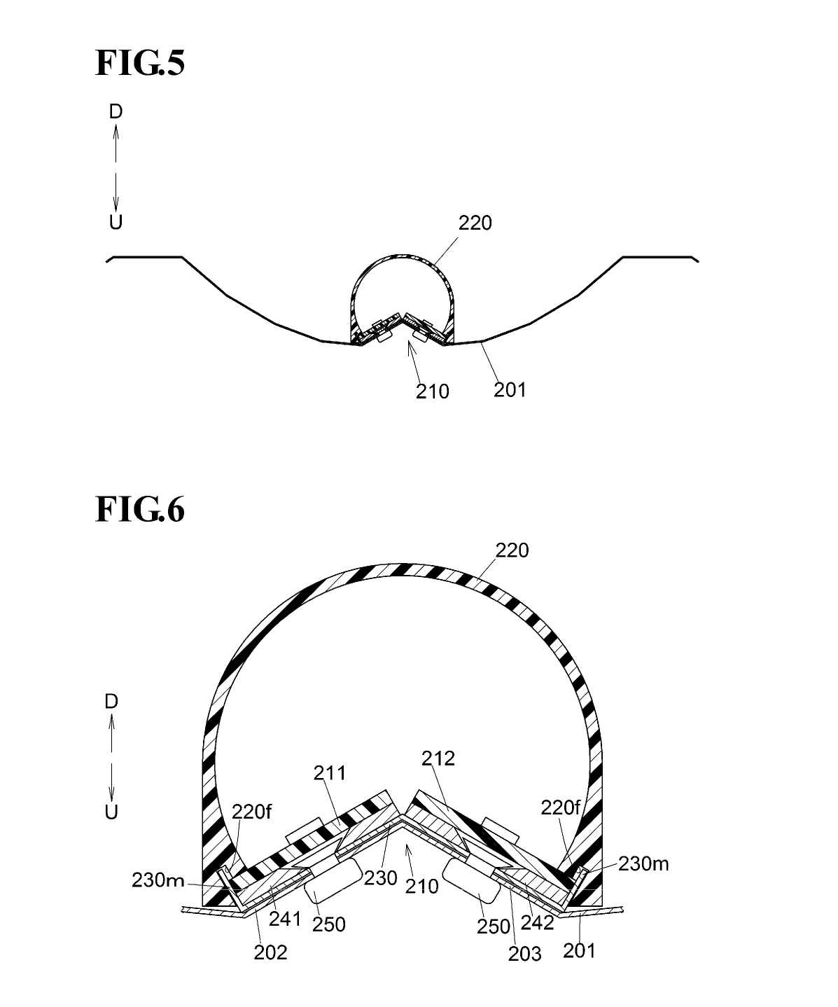

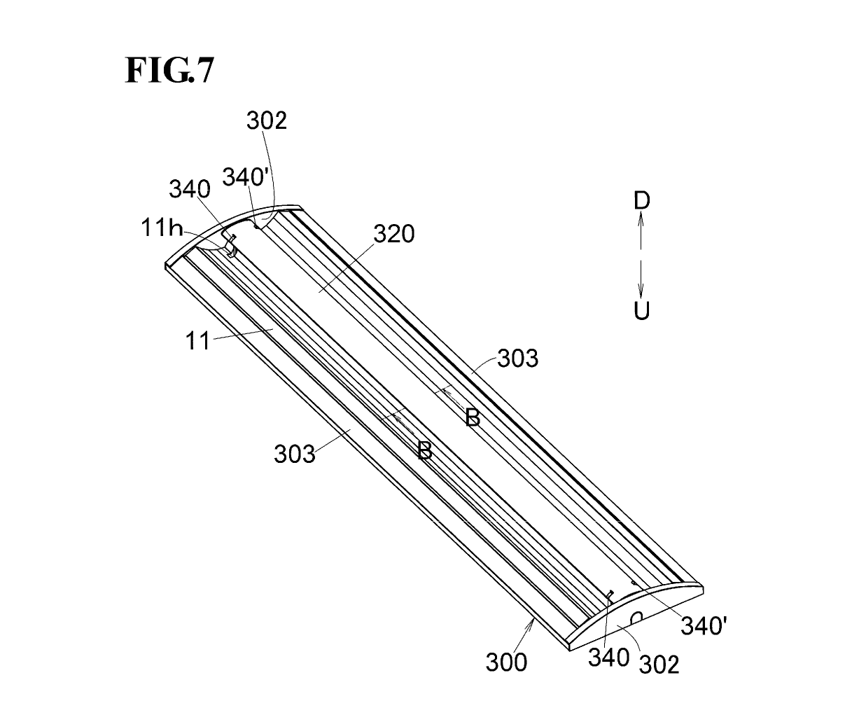

In the next, another embodiment 2 will be explained referring to drawings. Here, same reference numbers are denoted to the same portions as shown in the above mentioned embodiment, for which detailed explanation is omitted. FIG. 5 is a sectional view taken along the direction perpendicular to the lengthwise direction showing an illuminating tool for ceiling according to another embodiment 2 of the present invention and FIG. 6 is an enlarged sectional view taken along the direction perpendicular to the lengthwise direction showing an illuminating tool for ceiling according to another embodiment 2 of the present invention.

### (Reflection Plate 201)

As shown in FIG. 5, a reflecting plate 201 has plurality of rectangular reflecting faces formed by bending a rectangular sheet of plate material. The reflecting plate 201 is formed so that the rectangular reflecting faces are side by side in parallel manner with their long sides abutting each other. The reflecting plate 201 is formed to be of a substantially rectangular shape in plan view and symmetrical and nearly M-shaped as viewed in edgewise direction. The bent portion with a mountain-like shape 201 in the center of the reflecting plate 201 is formed to be convex downwards as the reflecting plate 201 is attached to the illuminating tool body.

As shown in FIG. 6, a first inclined face 202 and a second inclined face 203 as two symmetrical inclined faces are formed to be a bent mountain-like portion 210 in the reflecting plate 201. A first LED base plate 211, a first fixing plate 241 and an engaging plate 230 are attached to the first inclined portion 202. A second LED base plate 212, a second fixing plate 242 and an engaging plate 230 are attached to the second inclined portion 203. The first LED base plate 211 and the second base plate 212 are attached so that they are arrayed in two rows in lengthwise direction from on end to the other in the reflecting plate.

That is, the first LED base plate 211 and the second LED base plate 212 has different faces for attaching them to the reflecting plate 201 respectively that are inclined at a determined angle respectively. For this, the first LED base plate 211 and the second LED base plate 212 can emit light in different angle directions respectively. Here, the first LED base plate 211 and the second LED base plate 212 may be arrayed in two rows in a same plane on the reflecting plate 201.

### (Light Transmitting Cover 220)

As shown in FIG. 6, a light transmitting cover 220 is one covering the first LED base plate 211 and the second LED base plate 212 as two rows of LED base plates attached to the reflecting plate 201. Engaging female grooves 220f, 220f are engaging portions for making the light transmitting cover 220 slide along an engaging plate 230 in lengthwise direction and are engaged with the engaging male tags 230m, 230m of the engaging plate 230 respectively. While the light transmitting cover 220 is formed so as to cover two rows of LED base plates in another embodiment 2, it goes without saying that it may be formed so as to cover more than two rows of LED base plates.

### (Engaging Plate 230)

As shown in FIG. 6, the engaging plate 230 is bent so as to be attached extending over the first inclined face 202 and the second inclined face 203. The engaging plate 230 is formed to be nearly M-shaped and symmetrical in edgewise view. Both ends of the engaging plate 230 are bent at about 90 degrees and each end is formed to be an engaging male tag 230m. Engaging male tags 230m are engaging portions for allowing the light transmitting cover 220 to slide along the engaging plate 230 in lengthwise direction and are engaged with the engaging female grooves 220f.

As shown in FIG. 6, a first fixing plate 241 is a rectangular metal plate for securely fixing the engaging plate 230 and the reflecting plate 201. The first fixing plate 241 is fixed to the first inclined face 202 of the reflecting plate 201. The first fixing plate 241, the first inclined face 202 and the engaging plate 230 are fixed at plurality of points with rivets 250. A second fixing plate 242 is a rectangular metal plate for securely fixing the engaging plate 230 and the reflecting plate 201. The second fixing plate 242 is fixed to the second inclined face 203 of the reflecting plate 201. The second fixing plate 242, the second inclined face 203 and the engaging plate 230 are fixed at plurality of points with rivets 250. The first LED base plate 211 is attached to the first fixing plate 241 and the second LED base plate 212 is attached to the second fixing plate 242.

Two rows of LED base plate are provided for the reflecting plate in another embodiment 2. For this, the reflecting plate according to another embodiment 2 can emit light giving higher illuminance compared with one in which a row of LED base plate is provided. While the mountain-like portion 210 is formed in the center place of the reflecting plate 201 in bottom view, it goes without saying that it may be formed in another place of the reflecting plate 201. Further, while only one mountain-like portion 210 is formed, it goes without saying that two or more mountain-like portions may be formed on which LED base plates be attached respectively.

### Another Embodiment 3

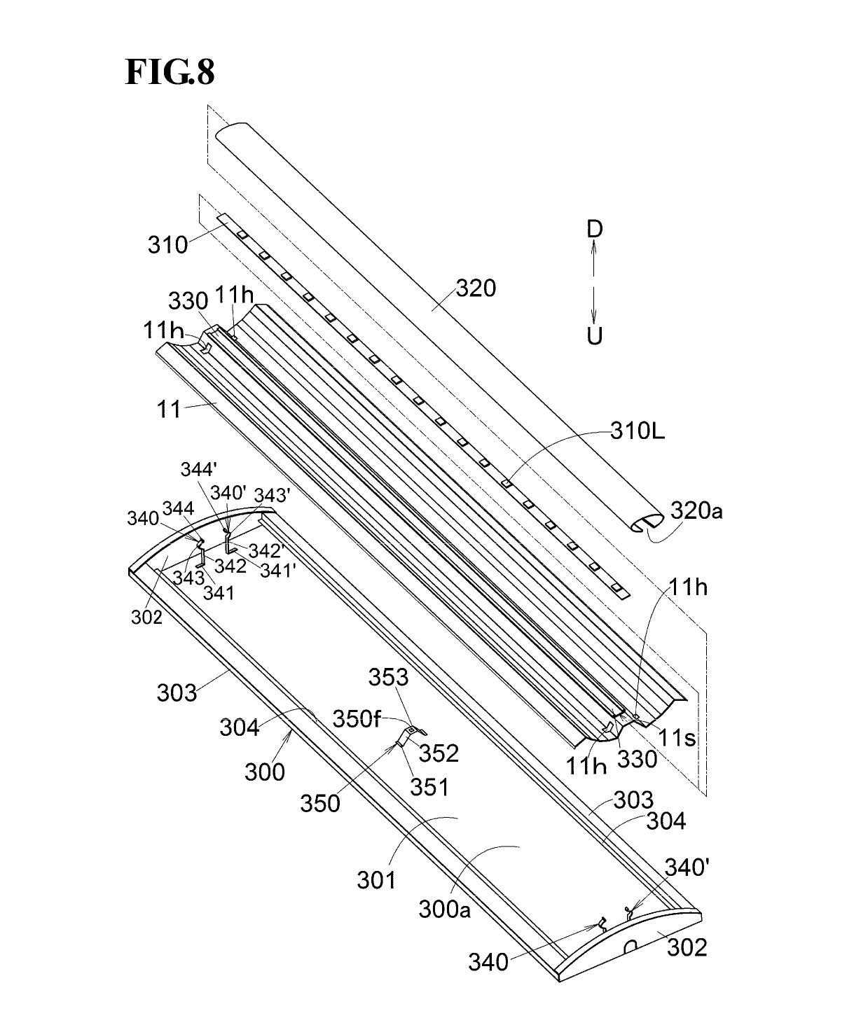

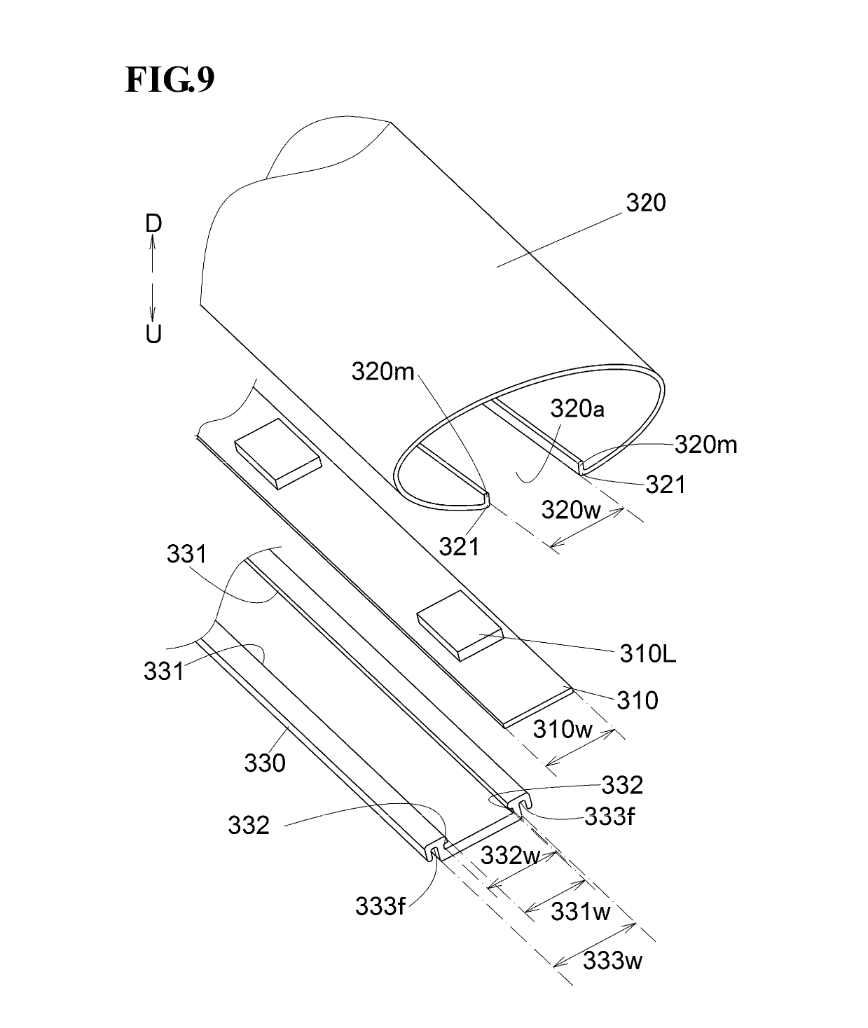

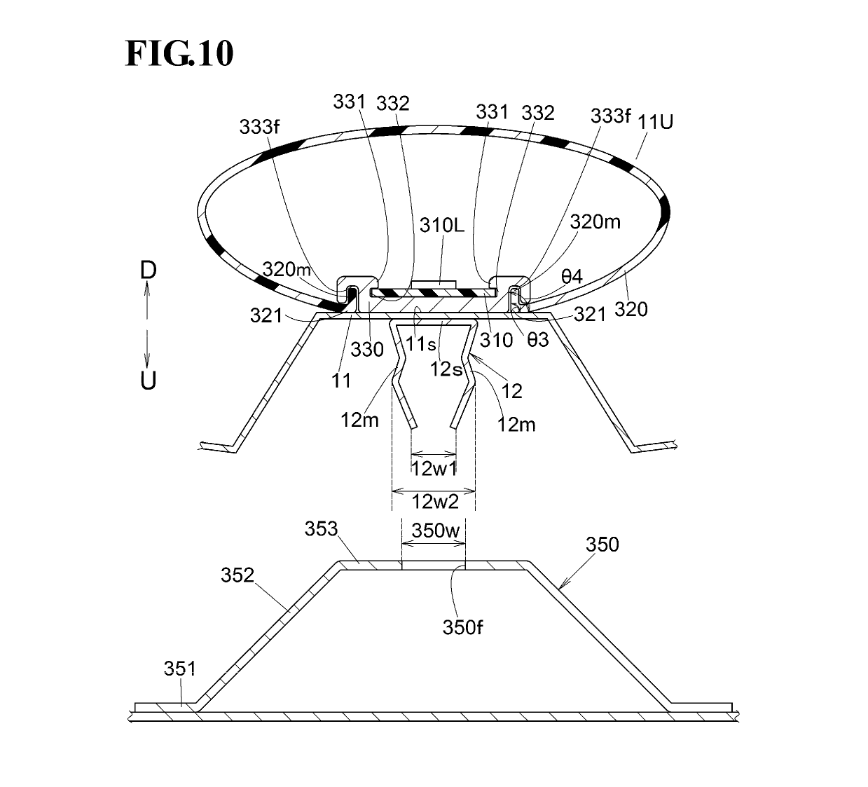

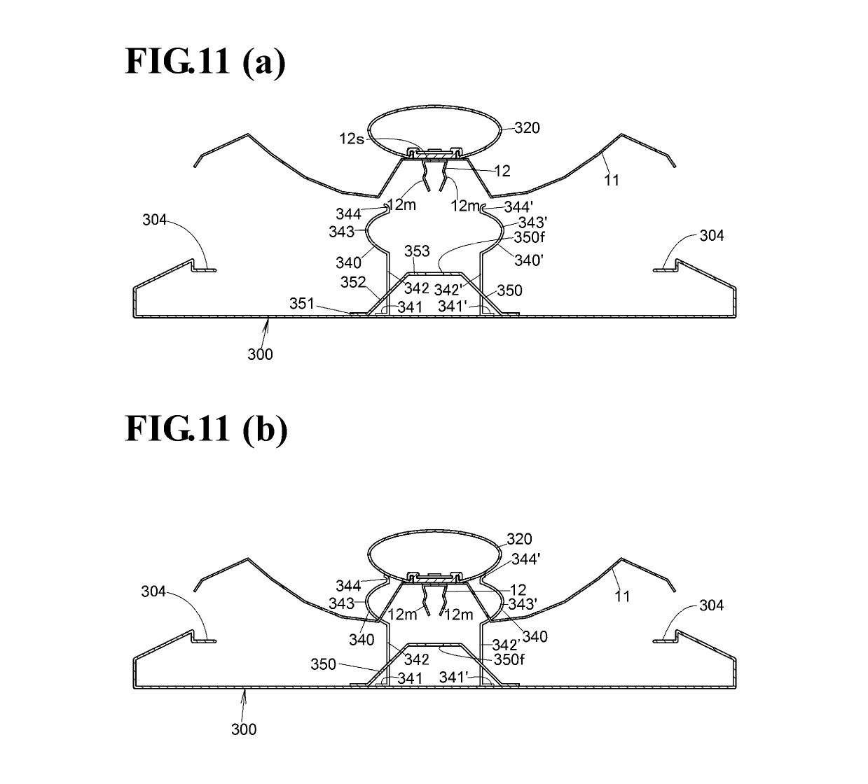

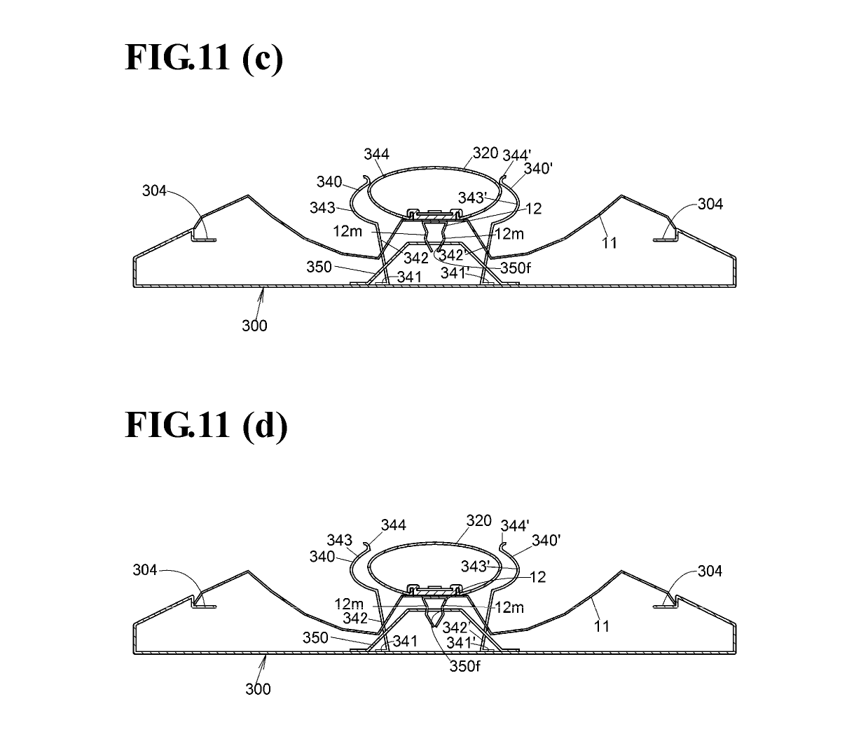

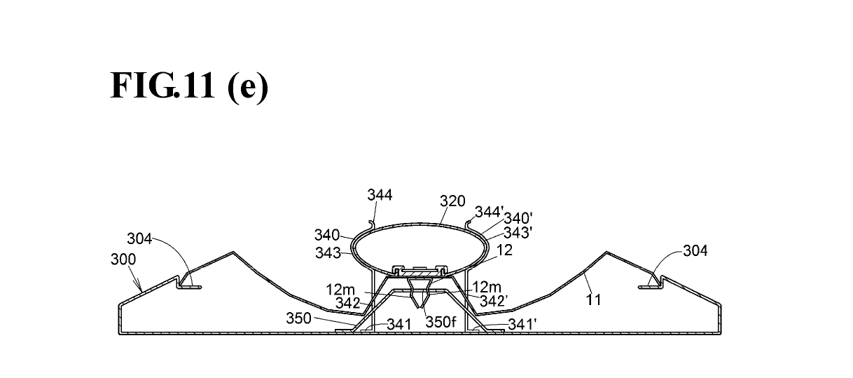

In the next, another embodiment 3 of the present invention will be explained referring to drawings. Here, in the explanation of another embodiment 3, same reference numbers are denoted to the same portions as shown in the above mentioned embodiment, for which detailed explanation is omitted. FIG. 7 is an external view showing a reflecting plate of an illuminating tool for ceiling according to another embodiment 3 of the present invention. FIG. 8 is a view showing the disintegrated parts of the illuminating tool for ceiling in a state where the reflecting plate, LED base plate and light transmitting cover are detached. FIG. 9 is a partially enlarged view showing the disintegrated parts of the illuminating tool for ceiling in a state where the reflecting plate, LED base plate and engaging plate are detached. FIG. 10 is an enlarged sectional view of FIG. 7 taken along the line B-B showing a state where the reflecting plate is not attached to the illuminating tool body. FIG. 11 is a plurality of sectional views showing a situation where a reflecting plate is being attached.

### (Illuminating Tool Body 300)

As shown in FIGS. 7 and 8, a reflecting plate 11 and a light transmitting cover 320 are attached to an illuminating tool body 300. The illuminating tool body 300 is formed to have a configuration that is rectangular in plan view and substantially rectangular with one lower side weakly curved in side view in a state where the illuminating tool body is installed on the ceiling. The illuminating tool body 300 is formed through working of bending a sheet of or sheets of aluminum or the like and composed of top plate 301, edge portions 303, a mounting portion 304 and end plates 302 made of plastic material such as polycarbonate resin, ABS resin or the like.

As shown in FIG. 8, the illuminating tool body 300 is equipped with a flat top plate 301 of rectangular shape and secured to the ceiling with fixing means such as screws or the like. The illuminating tool body 300 is composed of a top plate 301, end plates 302 and inclined plates 303 and forms a housing space 300a. The illuminating tool body 300 is so formed as to be a box-like shape with an open face confronting to the top plate 301. This housing apace 300a is formed so as to install a reflecting plate 11 within the illuminating tool body 300.

As shown in FIG. 7 or FIG. 8, end plates 302 are attached to the top plate 301 at both ends on the short sides so as to confront each other respectively. Packing members are attached to substantially center position of the inner faces of the end plates 302 respectively. As the packing members are of substantially same function and composition as the above mentioned packing members 110, explanation of them is omitted here. Edge portions 303 are provided along the lengthwise sides of the top plate 301 respectively, thus forming the mounting portion 304 on which the reflecting plate 11 is mounted.

### (Reflecting Plate 11)

As shown in FIGS. 7 and 8, two insertion holes 11h are formed at each of the short sides of the reflecting plate 11. The insertion holes 11h are through holes for inserting holding springs 340 individually. The reflecting plate 11 has plurality of rectangular reflecting faces formed on it by working of a sheet material through bending it. The reflecting plate 11 is formed so that the rectangular reflecting faces are side by side in parallel manner with their long sides abutting each other.

As shown in FIGS. 8 and 11, the reflecting plate 11 is of a substantially rectangular shape in plan view. The reflecting plate 11 is formed to have a symmetrical nearly arch shape in edgewise side views that is convex downwards at both ends and center. An attaching face 11s is formed to be a face parallel with the ceiling surface in the center of the reflecting plate 11 as viewed from side. LED base plate 310, a light transmitting cover 320 and an engaging plate 330 are attached to the attaching face 11s.

### (Engaging Male Tag 12)

As shown in FIG. 10, an engaging male portion 12 is fixed to substantially center position on the back side face (opposite to the reflecting face) of the reflecting plate 11. The engaging male portion 12 is formed of a fixing portion 12s and a pair of insertion plates 12m. The engaging male portion 12 is formed through bending a sheet of elastically deformable metal such as stainless steel to be a nearly U-shaped member having a fixing portion 12s and a pair of insertion plates 12m. The fixing portion 12s is formed to be flat and fixed to the attaching face 11s with screws, rivets or the like.

As shown in FIGS. 10 and 11, the insertion plates 12 are plate portions provided for engagement with an engaging female portion 350 fixed to the top plate 301. The insertion plates 12m are formed so that a pair of bent plates protrudes from the fixing portion 12s. The distance between the point end portions 12w1 of the pair of the insertion plates 12, 12 is the same as or narrower than the width 350w of an engaging hole 350f. The distance of some portion 12w2 of the pair of the insertion plates 12 is wider than the width 350w of the engaging hole 350f.

### (LED Base Plate 310)

As shown in FIG. 8, an LED base plate 310 with a flat and elongated shape is attached to the attaching face 11s of the reflecting plate 11 via the engaging plate 330 in an attachable and detachable manner. The LED base plate 310 is a base plate to which plurality of LED elements 310L are disposed to be fixed with an equal distance therebetween. Though not shown in FIG. 8, the LED base plate 310 is connected with a power source line and the LED elements 310 L emit light through supplying electric power. As shown in FIG. 9, the distance (width) 310w between the lengthwise sides of the LED base plate 310 is arranged to be the same as or narrower than the width 332w between the depths of inner grooves 332 and wider than the width 331w of the opening 331.

### (Light Transmitting Cover 320)

As shown in FIGS. 7 and 8, the light transmitting cover 320 is one covering the LED base plate 310 and a cover of a tubular shape (curled shape) with substantially elliptical section. The structure or material of the light transmitting cover 320 is similar as the light transmitting cover 20 mentioned above, so explanation of it is omitted here. The light transmitting cover 320 is partially cut out from one end to the other in lengthwise direction so that an opening 320a is formed. The light transmitting cover 320 is engaged with the engaging plate 330 to be fixed there.

(Engaging Male Tag 320m)

As shown in FIGS. 9 and 10, engaging male tags 320m, 320m are formed to protrude at the opening edges 321, 321 of the light transmitting cover on its side of the opening 320a respectively. A pair of engaging male tags 320m, 320m is formed to be bent inward by 90 degrees at the opening edges 321 in sectional view respectively. The pair of engaging male tags 320m, 320m is formed to be rails that extend in lengthwise direction of the light transmitting cover 320 from one end to the other. The engaging male tags 320m, 320m are engaging portions so as to allow the light transmitting cover 320 to slide in lengthwise direction of the engaging plate 330, being engaged with the engaging female grooves 333f, 333f of the engaging plate 330 respectively.

As shown in FIG. 10, the inclination angle θ3 of the pair of engaging male tags 320m, 320m is set to be the same as the inclination angle θ4 of the pair of engaging female grooves 333f, 333f mentioned later. Here, the inclination angle θ3 of the engaging male tag 320m is an angle between the plane of the opening 320a and the engaging male tag 320m and the inclination angle θ4 of the engaging female grooves 333f is an angle between the attaching face 11s and the engaging female groove 333f. The distance 320w between the pair of male tags 320m, 320m is set to be the same as the distance 333w between the pair of engaging female grooves 333f, 333f (see FIG. 9).

### (Engaging Plate 330)

As shown in FIGS. 8 and 9, the engaging plate 330 is a plate attached to the attaching face 11s of the reflecting plate 11 and is formed through extruding metal such as aluminum. A pair of engaging female grooves 333f is formed on one face of the engaging plate 330, while an opening concave 331 and a pair of inner grooves are formed on the other face thereof. As the engaging plate 330 is formed through extruding metal, it can be manufactured in plenty numbers with low expense. The engaging plate 330 is attached to be fixed to the reflecting plate 11 with rivets, screws or the like (not shown).

As shown in FIGS. 9 and 10, an opening elongated concave 331 with a certain width is formed on the other face of the engaging plate 330 in lengthwise direction thereof from one end to the other. A pair of inner grooves 332 with a certain width is formed within the opening elongated concave 331 in lengthwise direction from one end to the other thereof. The opening elongated concave 331 and the inner grooves 332 are formed continuously and those are formed so that the width 331w of the opening elongated concave 331 is smaller than the distance 332w between the depths of the pair of inner grooves 332. The width 331w of the opening elongated concave 331 is set to be smaller than the length 310w of the short side of the LED base plate 310. The width 331w of the opening elongated concave 331 is set to be larger than the width of each LED element 310L. The distance 332w between the depths of the pair of inner grooves 332 is set to be the same as or larger than the length 310w of the short side of the LED base plate 310.

As shown in FIG. 9, a pair of engaging female grooves 333f, 333f is formed on one face of the engaging plate 330 in lengthwise direction thereof from one end to the other. The pair of engaging female grooves 333f, 333f is grooves that are concave from one face side toward other face side. As shown in FIG. 10, the engaging female grooves 333f are formed near the ends on the long sides of the engaging plate 330. The engaging female grooves 333f are engaging portions for making the light transmitting cover 320 slide along the engaging plate 330 in lengthwise direction and are engaged with the engaging male tags 320m of the engaging plate 320 respectively. The distance 333w of the pair of engaging female grooves 333f, 333f is set to be the same as the distance 320w of the pair of engaging male tags 320m, 320m.

### (Holding Spring 340)

As shown in FIGS. 8 and 11, holding springs 340, 340′ are secured to the lower face of the top plate 301 at the ends on short sides respectively.

The holding springs 340, 340′ are ones for holding the light transmitting cover 320 and fixing the reflecting plate 11 to the illuminating tool body 300. The holding springs 340, 340′ are disposed on the top plate 301 so as to take position to be inserted into the insertion holes 11h respectively when the reflecting plate 11 is to be attached to the illuminating tool body. The holding springs 340, 340′ are two sets of springs disposed in opposed manner that is formed by bending an elastically deformable plate of a material such as stainless steel or the like.

As shown in FIGS. 8 and 11, the holding springs 340, 340′ are formed of fixing portions 341, 341′, leg portions 342, 342′, gripping portions 343, 343′ and point end portions 344, 344′. The gripping portion 343 is configured to be a shape of circular arch, parabolic arch or the like with determined dimension, inclination, etc. corresponding to the external shape of the light transmitting cover 320 so as to cover the light transmitting cover from outside. The point end portions 344, 344′ are formed so that the distance therebetween is widened gradually from upper side to lower side in order to allow the light transmitting cover 320 to be inserted easily between the gripping portions 343, 343′. The holding springs 340, 340′ can hold the ends of the light transmitting cover 320 at nearly end portions in lengthwise direction of the top plate 301.

As shown in FIGS. 8 and 11, the engaging female portion 350, being fixed to the lower face of the top plate 301 at substantially center position thereof, is provided for fixing the reflecting plate 11 to the illuminating tool body 300. The engaging female portion 350, being fixed to the top plate 301, is aimed to hold the engaging male portion 12. The engaging female portion 350 is formed of fixing portions 351 fixed to the top plate 301, holding leg portions 352 contouring the space for inserting the insertion plates 12m and an engaging face portion 353 with which the engaging male portion 12 is fixed. The engaging female portion 350 is formed by bending a plate of rigid metal (for example, a steel plate).

The engaging face portion 353, being a face formed for engagement with the engaging male portion 12 provided on the reflecting plate 11, is formed to be parallel with the top plate 301. An engaging through hole 350f for engagement is formed, through which the engaging male portion 12 is inserted, in substantially center position of the engaging face portion 353. In the engaging female portion 350, a space into which the insertion plates 12m of the engaging male portion 12 are inserted is contoured between the engaging face portion 353 and the top plate 301.

In the next, a method for attaching the LED base plate 310 and the light transmitting cover 320 to the reflecting plate 11 will be explained referring to FIGS. 8 and 9. At first, one end of the LED base plate 310 in lengthwise direction is brought to the inner grooves 332 at one end of the engaging plate 330 in lengthwise direction. Then the LED base plate 310 is pushed in the inner grooves 332 and caused to slide along the inner grooves 332 so that both ends of the LED base plate 310 are flush with both ends of the engaging plate 330.

In the next, as shown in FIGS. 8 and 9, one end of the pair of engaging male tags 32om is brought to one end of the pair of engaging female grooves 333f of the engaging plate 330 in lengthwise direction. As the light transmitting cover 320 is pushed in the engaging plate 330, the engaging male tags 320m, 320m are engaged with the engaging female grooves 333f, 333f and caused to slide along lengthwise direction of engaging plate 330. The light transmitting cover 320 is caused to slide on the reflecting plate 11 so that both ends of the light transmitting cover 320 in lengthwise direction are flush with both ends of the engaging plate 330 in lengthwise direction. The reflecting plate unit is assembled through attaching the LED base plate 310 and the light transmitting cover 320 to the reflecting plate 11.

In the next, a method for attaching a reflecting unit 11U to the illuminating tool body 300 will be explained. As shown in FIG. 11(a), the reflecting unit 11U is mated with the illuminating tool body 300. The holding springs 340 are inserted through the insertion holes 11h (not seen in the figure) formed in the reflecting plate 11. As shown in FIG. 11(b), the light transmitting cover 320 is brought to the point end portions of the holding springs 340. The light transmitting cover 320 is pushed in between the holding springs 340, 340′ towards the top plate 301.

As shown in FIG. 11(c), when the light transmitting cover 320 is pushed in with a force stronger than a determined strength, the leg portions 342, 342′ of the holding springs 340 are deformed elastically and the distance between two sets of point end portions 344, 344′ is widened gradually. At this time, a pair of insertion plates 12m, 12m are inserted into the engaging hole 350f. As shown in FIG. 10, the distance 12w2 between parts of the insertion plates 12m, 12m is set to be wider than the width 350w of the engaging hole 350f. Due to this, as the light transmitting cover 320 is further pushed in, the pair of insertion plates 12m, 12m are inserted through the engaging hole 350f with elastic deformation, as shown in FIG. 11(d). After this, the insertion plates 12m, 12m are fixed with elastic force in a state where they are inserted through the engaging hole 350f.

As shown in FIG. 11(e), the leg portions 342 return to the initial state after having been deformed elastically and the light transmitting cover 320 are held with covered by two sets of gripping portions 343, 343′. That is, the reflecting plate 11 to which the light transmitting cover 320 is attached is attached to the illuminating tool body 300. At this time, the insertion plates 12m, 12m are in a fixed state by the engaging hole 350f. That is, the state is attained where the engaging male portion 12 is fixed by the engaging female portion 350 and the reflecting plate 11 is attached to the illuminating tool body 300.

The reflecting plate 11 explained concerning another embodiment 3 is fixed by the holding springs 340 at both ends and fixed by the engaging male portion in center position. Owing to this, it does not slacken easily from the illuminating tool body 300. The holding springs 340 fix the light transmitting cover 320 at nearly end portions without fixing it at center position. Consequently, the shade of the holding springs 340 is not conspicuous when the LED elements 310L emit light.

While embodiments of the present invention have been explained above, the present invention is not restricted to these embodiments. It goes without saying that modification can be made without changing the objects or gist of the present invention. Explanation is made concerning the illuminating tool directly fixed to the ceiling in which the illuminating tool is installed with a top plate on the ceiling. However, it goes without saying that the present invention is not limited to this but may be applied to an illuminating tool for embedding into the ceiling.

What is claimed is:

1. A reflecting plate unit comprising:
a reflecting plate (1) attached to an illuminating tool for ceiling provided on the ceiling in attachable and detachable manner with the back face opposite to the face of the side attached to the ceiling forming a face that reflects light,
an LED base plate (10) which is attached to the reflecting plate (1) and to which plurality of LED elements are attached side by side in lengthwise direction,
a light transmitting cover (20) which is composed of substantially cylindrical member with an opening (20a) cut out from one end to the other in lengthwise direction, which is engaged with the reflecting plate (1) in attachable and detachable manner so as to cover the LED base plate (10) and which transmits light in a part or as a whole,
engaging portions (30m, 20f) provided in the reflecting plate (1) and the light transmitting cover (20) respectively for causing the reflecting plate (1) and the light transmitting cover (20) to be engaged with each other and allowing them to slide one relative to the other in lengthwise direction.

2. A reflecting plate unit according to claim 1, wherein the engaging portions comprises:
engaging male tags (30m) formed on the reflecting face so as to protrude from the side of the reflecting face, and
engaging female grooves (20f) provided in the light transmitting cover as grooves formed to be engaged with the engaging male tags.

3. A reflecting plate unit according to claim 2, wherein
the engaging male tags (30m) are formed in lengthwise direction of the reflecting plate from one end to the other, and
the engaging female grooves (20f) are formed in lengthwise direction of the light transmitting cover (20) from one end to the other.

4. A reflecting plate unit according to claim 3, wherein
the engaging male tags (30m) are formed to be rails that extend outside along the two lengthwise sides of the LED base plate (10), and
the engaging female grooves (20f) are formed at opening edges (21) as the both ends of the light transmitting cover (20) on the opening (20a) side.

5. A reflecting plate unit according to claim 4, wherein
the engaging male tags (30m) are formed to have a determined inclination angle to the reflecting face, and
the engaging female grooves (20f) are formed to have a determined inclination angle to the plane of the opening (21).

6. A reflecting plate unit according to claim 5, wherein
the engaging male tags (30m) are formed by bending a engaging plate (30) consisting of a plate, and
the engaging plate (30) is attached to be sandwiched between the reflecting face and the LED base plate (10).

7. A reflecting plate unit according to claim 6, wherein
a fixing plate (140) for fixing the engaging plate (30) to the reflecting face is attached between the LED base plate (10) and the engaging plate (30),
through holes for causing bolts or rivets to be inserted at more than one positions of the fixing plate, the LED base plate and the engaging plate, and
the fixing plate, the LED base plate and the engaging plate fastened with the bolts or rivets.

8. An illuminating tool for ceiling in which the reflecting plate unit according to claim 1 is provided, which comprises:
an illuminating tool body (100) comprising a top plate (101) of a flat shape to be attached to ceiling, having an opening on the side opposed to the top plate and contouring a housing space (100a) for housing the reflecting plate unit,
end plates 102 that are provided at both ends on short sides of the top plate and to which packing members (110) for sealing both ends of the light transmitting cover (20) are provided in attachable and detachable manner, and
fixing means for fixing the reflecting plate unit to the illuminating tool body (100).

9. An illuminating tool for ceiling according to claim 8, wherein
the fixing means comprises:
through holes formed in each of the reflecting plate (1), the LED base plate (10), the light transmitting cover (20) and the engaging plate (30), holes for screw (104h) formed in the securing base (104) for the reflecting plate, and
screws (40) inserted through the through holes and screwed into the holes for screw respectively.

10. A reflecting plate unit according to claim 1, wherein
the engaging portions comprising:
engaging female grooves (333f) formed in the engaging plate (330) attached to the reflecting face and consisting of grooves formed on one face of the engaging plate (330) from one side to the other in lengthwise direction, and
engaging male tags (320m) formed at the opening edges (321) on the opening (320a) side of the light transmitting cover (320) from one side to the other in lengthwise direction and formed to be rails for engagement with the engaging female grooves (333f).

11. A reflecting plate unit according to claim 10, wherein
the engaging male tags (320m) are formed so as to protrude inwards of the light transmitting cover (320).

12. A reflecting plate unit according to claim 11, wherein
the engaging plate (330) has:
an opening concave (331) extending from one end to the other in lengthwise direction with width smaller than the short side of the LED base plate (310) and larger than the width of the LED element (310L), and
inner grooves (332) formed on the engaging plate (330) from one end to the other continuously to the opening concave (331) at both sides and formed so that the distance between the depths of inner grooves is substantially the same as the short side of the LED base plate (310);
wherein the LED base plate (310) is provided so that it can slide relative to and along the inner grooves (332) in lengthwise direction and is provided so as to be attached to and detached from the engaging plate (330).

13. A reflecting plate unit according to claim 12, wherein
the engaging plate (330) is made of aluminum molded through extrusion.

14. An illuminating tool for ceiling in which the reflecting plate unit according to claim 10 is provided, which comprises:
an illuminating tool body (300) comprising a top plate (301) of a flat shape to be attached to ceiling, having an opening on the side opposed to the top plate (301) and contouring a housing space (300a) for housing the reflecting plate unit, and
holding springs (340) provided on both ends on the short sides of the top plate for holding the light transmitting cover (320).

15. An illuminating tool for ceiling according to claim 14, comprising:
engaging male portion (12) formed by bending a plate to be in substantially U-shape and fixed to the side opposite to the reflecting face of the reflecting plate (11) at substantially center thereof, and
engaging female hole portion (350) fixed to the lower side of the top plate (301) at substantially center thereof and having an engaging hole (350f) as a through hole for inserting the engaging male portion (12) formed thereon;
wherein the engaging male portion (12) is fixed at the engaging female hole potion (350f) with elastic force and the reflecting plate (12) is fixed to the illuminating tool body (300).
